(19) United States
(12) Patent Application Publication
(10) Pub. No.: US 2015/0111125 A1
(43) Pub. Date: Apr. 23, 2015

(54) ALIGNMENT FEATURE AND METHOD FOR ALIGNMENT IN FUEL CELL STACKS

(71) Applicants: Daimler AG, Stuttgart (DE); Ford Motor Company, Dearborn, MI (US)

(72) Inventor: Simon Farrington, Vancouver (CA)

(21) Appl. No.: 14/515,553

(22) Filed: Oct. 16, 2014

Related U.S. Application Data
(60) Provisional application No. 61/893,149, filed on Oct. 19, 2013.

(51) Int. Cl. H01M 8/24; H01M 8/10

(52) U.S. Cl. CPC H01M 8/2465; H01M 8/1018; H01M 2008/1095
USPC 429/465; 429/479; 29/623.1

(57) ABSTRACT

Alignment features and methods for their use are disclosed for purposes of aligning adjacent bipolar plates, and also optionally the membrane electrode assemblies as well as the plates making up the bipolar plates, during assembly of solid polymer electrolyte fuel cell stacks. The alignment features are located within common datum openings and advantageously can be in-plane with the bipolar plates. This provides for improved alignment and manufacturability.

### BACKGROUND

1. Field of the Invention

This invention relates to designs and methods for aligning components during assembly of solid polymer electrolyte fuel cell stacks. In particular, it relates to alignment features for aligning bipolar plates and optionally membrane electrode assemblies and the plates within bipolar plates.

2. Description of the Related Art

Fuel cells such as solid polymer electrolyte fuel cells electrochemically convert fuel and oxidant reactants, (e.g. hydrogen and oxygen or air respectively), to generate electric power. Solid polymer electrolyte fuel cells generally employ a proton conducting polymer membrane electrolyte between cathode and anode electrodes. The electrodes contain appropriate catalysts and typically also comprise conductive particles, binder, and material to modify wettability. A structure comprising a proton conducting polymer membrane sandwiched between two electrodes is known as a membrane electrode assembly. Such assemblies can be prepared in an efficient manner by appropriately coating catalyst mixtures onto the polymer membrane, and assemblies prepared in this manner are commonly known as catalyst coated membranes (CCMs). For handling and sealing purposes, CCMs are often framed and such frames typically comprise two polymeric films that are bonded to and sandwich the CCM at the edge. The frame can be handled more easily than the CCM itself and the frame can also be used as a sealing gasket.

Usually, anode and cathode gas diffusion layers (GDLs) are employed adjacent their respective electrodes on either side of a catalyst coated membrane. The gas diffusion layers serve to uniformly distribute reactants to and remove by-products from the catalyst electrodes. Fuel and oxidant flow field plates are then typically provided adjacent their respective gas diffusion layers and the combination of all these components represents a typical individual fuel cell assembly. The flow field plates comprise flow fields that usually contain numerous fluid distribution channels. The flow field plates serve multiple functions including: distribution of reactants to the gas diffusion layers, removal of by-products therefrom, structural support and containment, and current collection. Often, the fuel and oxidant flow field plates are assembled into a unitary bipolar plate in order to incorporate a coolant flow field therebetween and/or for other assembly purposes. Because the output voltage of a single cell is of order of 1V, a plurality of such fuel cell assemblies is usually stacked together in series for commercial applications. Fuel cell stacks can be further connected in arrays of interconnected stacks in series and/or parallel for use in automotive applications and the like.

To maximize power density capability, the size of the fuel cell stack is kept as small as possible and thus the components and features formed therein are kept as small as is practically possible. Due to the small size of the features involved and the numerous components making up a complete fuel cell stack, it is difficult to consistently maintain tight tolerances in alignment during assembly. Yet less than perfect alignment of these components can have a substantial negative effect on the performance of the fuel cell stack. The alignment of the features in the fuel cells with respect to each other is thus a major design consideration and constraint.

In considering the alignment process during stack assembly, there are several areas of concern: 1) the alignment of the CCMs and GDLs with respect to the edges of flow fields on the adjacent flow field plates; 2) the alignment of the frames of MEAs with respect to the fluid ports and edges of adjacent flow field plates; 3) the alignment of interface plates, bus plates, and end plates in the stack; 4) the alignment of anode and cathode flow fields between adjacent bipolar plates; and 5) the alignment of anode and cathode plates within the bipolar plate assemblies.

With regards to 1), misalignment can result in minor material utilization inefficiency (e.g. catalyst not used efficiently) and has a relatively small impact on stack performance. Acceptable alignment can typically be obtained by incorporating appropriate features on the components themselves, within easily achievable tolerances.

With regards to 2), misalignment can lead to problems with electrical shorting, flow resistance in the headers, and water management in the cells. With regards to 3), misalignment can lead to problems with packaging clearance of the overall stack, fluid port alignment, etc. Neither however have a significant direct impact on stack performance. In both these cases, acceptable alignment can typically be obtained by aligning datum features on the components with datum features on the external fixtures used for assembly.

With regards to 4) however, misalignment directly affects the overlap of landings and channels in the flow fields on the plates. Relatively small misalignments here can lead to substantial loss of the performance of cells in the stack, as well as to problems with water management and structural stability of the stack. And with regards to 5), misalignment here contributes to the problems associated with 4) and also can lead to problems with electrical connection at that interface and to flow resistance of coolant within the bipolar plates. Alignment within and between bipolar plates has been obtained in the past in various manners. Unfortunately, given the feature sizes and number of components involved, present alignment methods are not as reliable or as accurate as desired.

A method for obtaining alignment within and between bipolar plates is by aligning datum features on the electrode plates with datum features on external assembly fixtures. However there are several drawbacks to this approach. Importantly, the tolerances on the external assembly features themselves add to the total alignment tolerance stack up. And these tolerances are typically large enough that the typical alignment tolerance stack up between the anode and cathode flow fields of a cell in the stacking direction can become large enough to have a dramatic effect on cell performance. Thus, this approach inherently results in less accurate relative positioning of the components than is desired. Further, there is manufacturing process risk in that compressing a stack that is aligned to external datums carries a risk of damaging the components against the hard datum features during the compression cycle. There is also an undesirable increase in process cycle time and cost because the picking and placing operations involved become slower as the requirement for accuracy increases. In addition, more expensive equipment is required when more precise handling is required.

Another alternative for obtaining alignment within and between bipolar plates is by incorporating appropriate alignment features on the components themselves. Conventionally however, these features do not lie in the planes of the bipolar plates. That is, these features stick out or stand proud from the primary surfaces of the flow field plates (i.e. the flow field landings) in order that they can be contacted with adjacent plates during stacking and thereby affect alignment with them. These out-of-plane features however make the components difficult to stack together (typically done in gluing or post-bake fixtures which would require clearance holes for the out-of-plane features and rough aligning to ensure clearance). Further the presence of these features require undesirable complications to several other assembly processes, including plate embossing (where the tooling requires small areas of standing steel above the main embossing feature planes, necessitating dramatically increased tool machining to remove the surrounding material, or the use of inserts containing these features which creates additional alignment inaccuracy), plate flattening after molding (which can no longer be done between flat surfaces, thus requiring additional fixtures and component alignment), and plate bonding (done in a heated press and thus requires clearance for upstanding features and additional component alignment). All the preceding undesirably increase tooling cost and process cycle time.

In yet another alternative, US20060051651 discloses an aligning method for repeating and non-repeating units in a fuel cell stack. Here, alignment members are incorporated which are selectively operable between first and second positions, and which are configured to interact with internal alignment features on components in the fuel cell stack. The first position corresponds to being engaged with alignment features, and the second position corresponds to being disengaged with alignment features.

There remains a continuing need to obtain simpler and better alignment of the components during assembly of such fuel cell stacks. This invention addresses these needs and provides further related advantages.

### SUMMARY

The present invention provides for simpler constructions and methods for aligning components during the manufacture of solid polymer electrolyte fuel cell stacks. The components which can be aligned using the invention include the bipolar plates in the stack, the membrane electrode assemblies, and plates making up the bipolar plates (e.g. the plates in bipolar plate assemblies). Here, alignment features are located within common datum openings and advantageously can be in-plane with the bipolar plates. The invention provides for improved alignment and manufacturability.

Specifically, a solid polymer electrolyte fuel cell stack comprises a plurality of membrane electrode assemblies and a plurality of bipolar plates separating the membrane electrode assemblies. Each bipolar plate comprises an anode side, a cathode side, and a common datum opening, and the common datum openings of each bipolar plate are in alignment in the stack. The stack also comprises a plurality of alignment features in which there is one alignment feature for each adjacent pair of common datum openings in adjacent bipolar plates. Further, each alignment feature engages the common datum opening of the anode side of one bipolar plate and the common datum opening of the cathode side of an adjacent bipolar plate. An advantage of this approach is that each alignment feature can lie within the planes defined by the external surfaces of the bipolar plates to which it is engaged, and thus the bipolar plates can be free of upstanding features. For various reasons, this can simplify the manufacturing process.

For ease of assembly, the alignment features preferably remain in the stack after assembly and are thus non-electrically conductive. Suitable alignment features can simply be made of molded polymer. The alignment features used here can have various shapes, including disc shaped or ring shaped.

In some embodiments where the common datum opening is a fluid port in the bipolar plate, the alignment features can comprise a radial slot which is oriented appropriately on assembly to allow for flow of the fluid. In some embodiments, both the common datum openings in the bipolar plates and the peripheries of the alignment features can be tapered to ease assembly and improve accuracy.

In yet other embodiments employing framed membrane electrode assemblies, the alignment features can comprise a peripheral slot which can advantageously be used to additionally align the framed membrane electrode assemblies. Such assemblies comprise a frame which also comprises a common datum opening in alignment with the common datum openings in the bipolar plates. To accomplish alignment, each frame is trapped in the peripheral slot of an alignment feature.

In still other embodiments employing bipolar plate assemblies, the alignment features can optionally be used to align the plates making up the bipolar plate assemblies. Such assemblies typically comprise an anode plate bonded to a cathode plate. To accomplish alignment here, each alignment feature engages the common datum opening of the anode plate and the common datum opening of the cathode side in one of the bipolar plates.

Alternatively, in embodiments employing bipolar plate assemblies, the anode plate and cathode plate in each bipolar plate assembly can instead comprise an additional common datum opening and an additional alignment feature. Here, the additional alignment features can be used to engage the additional common datum opening of the bonded side of the anode plate and the additional common datum opening of the bonded side of the adjacent cathode plate in each bipolar plate assembly.

The invention also includes related unit cell assemblies which are typically used in the construction of fuel cell stacks. Here, such unit cell assemblies comprise a membrane electrode assembly, a bipolar plate adjacent the membrane electrode assembly in which the bipolar plate comprises an anode side, a cathode side, and a common datum opening, and an alignment feature in the common datum opening of the bipolar plate.

Further, the invention also includes related methods for aligning a plurality of bipolar plates during assembly of a solid polymer electrolyte fuel cell stack. The method comprises the steps of:
incorporating a common datum opening in each bipolar plate such that the common datum openings are all in alignment,
incorporating a plurality of alignment features in the common datum openings, and stacking the membrane electrode assemblies and the bipolar plates such that each alignment feature engages the common datum opening of the anode side of one bipolar plate and the common datum opening of the cathode side of an adjacent bipolar plate.

As mentioned above, the method can advantageously comprise selecting each alignment feature such that it lies within the planes defined by the external surfaces of the bipolar plates to which it is engaged. Further, the method can additionally comprise aligning the plurality of membrane electrode assemblies during assembly of the fuel cell stack. This can be accomplished using the steps of:
employing membrane electrode assemblies comprising a frame,
incorporating a common datum opening in each frame that is in alignment with the common datum openings in the bipolar plates,
incorporating a peripheral slot in each alignment feature, and
trapping each frame in the peripheral slot of an alignment feature.

In the preceding, the alignment features may remain in the stack after assembly or optionally they may be removed after the alignment and stack assembly steps are otherwise completed. Thus, the method of the invention can also comprise removing (e.g. by punching out) the plurality of alignment features in the common datum openings after stacking the membrane electrode assemblies and the bipolar plates.

These and other aspects of the invention are evident upon reference to the attached Figures and following detailed description.

### BRIEF DESCRIPTION OF THE DRAWINGS

FIG. 1 shows an exploded view of an exemplary solid polymer fuel cell stack of the prior art.

FIGS. 2a, 2b, and 2c show several different embodiments of an alignment feature of the invention, namely a disc shaped feature, a disc shaped feature comprising a radial slot, and a disc shaped feature comprising a peripheral slot respectively.

FIG. 3a shows a side sectional schematic view of the edge of a framed membrane electrode assembly comprising an alignment feature like that shown in FIG. 2c.

FIG. 3b shows an isometric sectional schematic view of a fuel cell stack in the vicinity of the common datums of two adjacent bipolar plate assemblies comprising alignment features like that shown in FIG. 2c.

FIG. 4 shows a top view of a bipolar plate assembly in a fuel cell stack comprising alignment features with a radial slot which are functionally similar to that shown in FIG. 2b. The view is in the vicinity of a fluid port which serves as the common datum.

### DETAILED DESCRIPTION

Herein, the following definitions have been used. The phrase “bipolar plate” refers to a plate or to a plate assembly whose opposing major surfaces are in electrical contact with the anode of one cell and the cathode of an adjacent cell respectively. A bipolar plate assembly typically comprises an anode plate and a cathode plate which have been bonded together in electrical contact.

The phrase “lies within the planes” has been used to indicate the relative position of alignment features with respect to the bipolar plates. Herein, when an alignment feature lies within the planes defined by the external surfaces of the bipolar plates to which it is engaged, it means that the feature does not stick out beyond, or is upstanding from, those planes.

In reference to an alignment feature, the phrase “radial slot” refers to a slot that provides an adequate fluid path from the centre of the feature to its edge or periphery.

In reference to an alignment feature, the phrase “peripheral slot” refers to a slot formed along the periphery or edge of the feature.

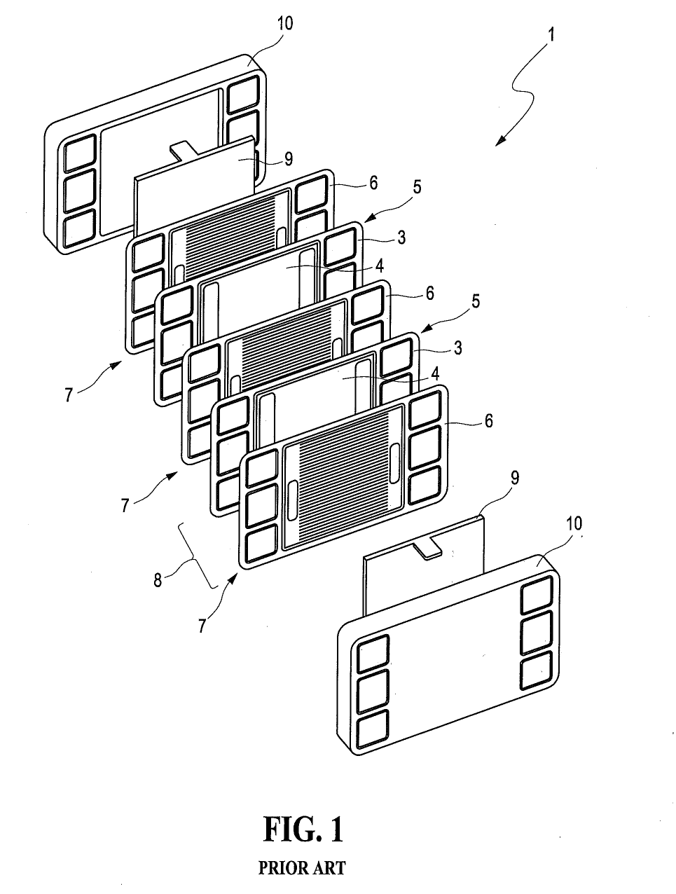

FIG. 1 shows an exploded view of an exemplary solid polymer fuel cell stack of the prior art. A typical stack may actually comprise several hundred fuel cells stacked in series. However, for illustrative purposes only a few are shown here. In stack 1, each cell contains a membrane electrode assembly (MEA) which is often provided in the form of a catalyst coated membrane (CCM, not visible in FIG. 1). Each CCM here is framed and thus comprises peripheral frame 3. On opposite sides of the CCM are gas diffusion layers (GDLs), namely anode GDL 4 and cathode GDL (not visible in FIG. 1), which may be glued to the CCM. Together, the CCM, peripheral frame 3, anode GDL 4, and the cathode GDL form a unitary membrane electrode framed assembly 5.

Adjacent each GDL in membrane electrode framed assembly 5 are an anode plate (not visible in FIG. 1) and cathode plate 6 respectively. Fuel and oxidant flow fields are formed on the anode plates and cathode plates 6 respectively on the surfaces facing anode GDLs 4 and the cathode GDLs respectively. Coolant flow fields are formed on the anode plates and cathode plates 6 on the surfaces opposite anode GDLs 4 and the cathode GDLs. As discussed above, usually unitary bipolar plate assemblies are made first (by bonding the coolant flow field surfaces of an anode plate and a cathode plate together) before assembling the rest of the fuel cell stack. Thus, as shown in FIG. 1, an anode plate and cathode plate 6 are combined to form numerous bipolar plate assemblies 7. Further, for assembly convenience, repeating units known as unit cell assemblies 8 are then prepared. For instance, a single unit cell assembly 8 may comprise membrane electrode framed assembly 5 and a bipolar plate assembly 7. A series of unit cell assemblies 8 can thus be stacked together to make up most of fuel cell stack 1. The ends of the stack however are terminated with individual cell components as required. Hardware is provided at each end of stack 1 to compress and contain the numerous components in the stack. In FIG. 1, this hardware includes interface plates 9 and end plates 10. Straps, tie rods, or other mechanisms (none shown in FIG. 1) are used to locate and provide compression to end plates 10. Finally, stack 1 may comprise other components such as bus plates or the like. As is evident from FIG. 1, there are numerous components in a typical fuel cell stack and achieving desirable alignment of all these is difficult because the allowable tolerances are so tight.

According to the method of the invention, a plurality of preferably non-electrically conductive alignment features are used to assemble stack 1. Common datum openings are provided in adjacent bipolar plate assemblies 7 and one alignment feature is used in each adjacent pair of these common datum openings. When assembled, each alignment feature engages the common datum opening of the anode side or plate of one bipolar plate assembly 7 and the cathode side or plate 6 of an adjacent bipolar plate assembly 7. In preferred embodiments, each alignment feature lies within the planes defined by the external surfaces of the bipolar plates to which it is engaged. In principle, the alignment features may be removed after all the components are appropriately aligned, stacked, and compressed and contained between end plates 10. To reduce the number of operations required, to help prevent any subsequent shifting of components, and to avoid disturbing or damaging the components, preferably the alignment features remain in stack 1 after assembly.

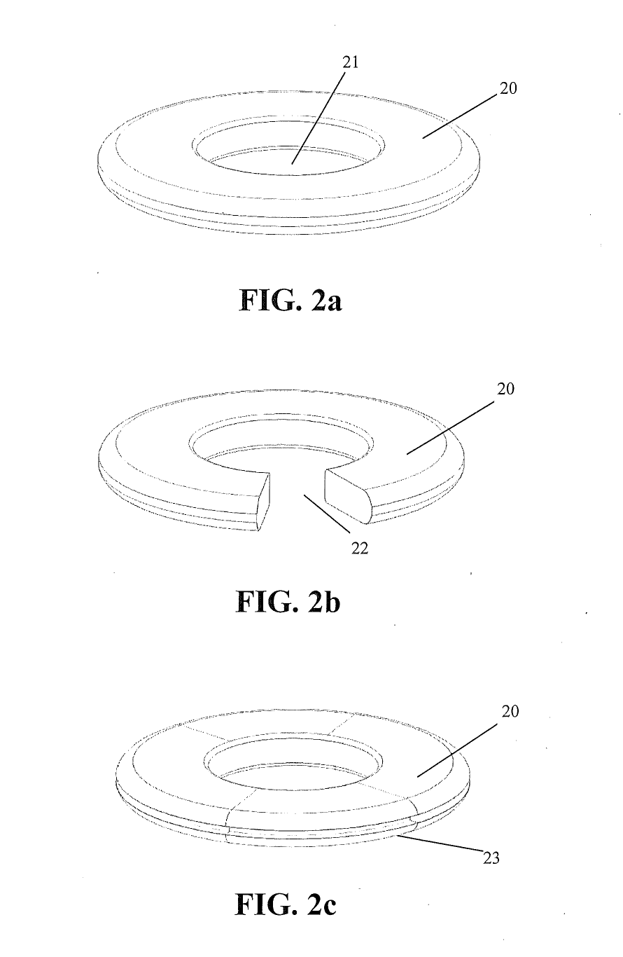

FIGS. 2a, 2b, and 2c show several different embodiments of alignment features that are suitable for use in circular common datum openings. In cases where the alignment features remain in the stack after assembly, the features must essentially be non-electrically conductive because they contact plates of different polarities. Further, the material used to make the features must be able to tolerate the chemical and temperature conditions experienced during operation. In addition, the materials employed must have suitable mechanical properties for assembly and alignment purposes. A certain stiffness is required for locating purposes, but in certain embodiments some flexibility may also be desirable (e.g. if snap fit steps are involved in assembly). A variety of molded polymer materials are known in the art which may be considered here, including polypropylene, polyethylene napthalate, PTFE, polyvinylidene fluoride, or thermosetting plastics such as phenolics, liquid crystal polymers, and so forth.

FIG. 2a shows disc shaped alignment feature 20 having a central hole 21 which is useful to include for handling purposes. In certain embodiments, hole 21 may be necessary to allow for the flow of fluids (e.g. if the common datum also serves as a fluid passage). The top and bottom edges or periphery of feature 20 are tapered to allow for easier location and insertion and/or removal from the common datums. And the thickness of disc shaped alignment feature 20 is preferably less than that of a bipolar plate assembly 6, 7, thereby allowing the feature to lie within the planes of the bipolar plate assembly 6, 7 after assembly.

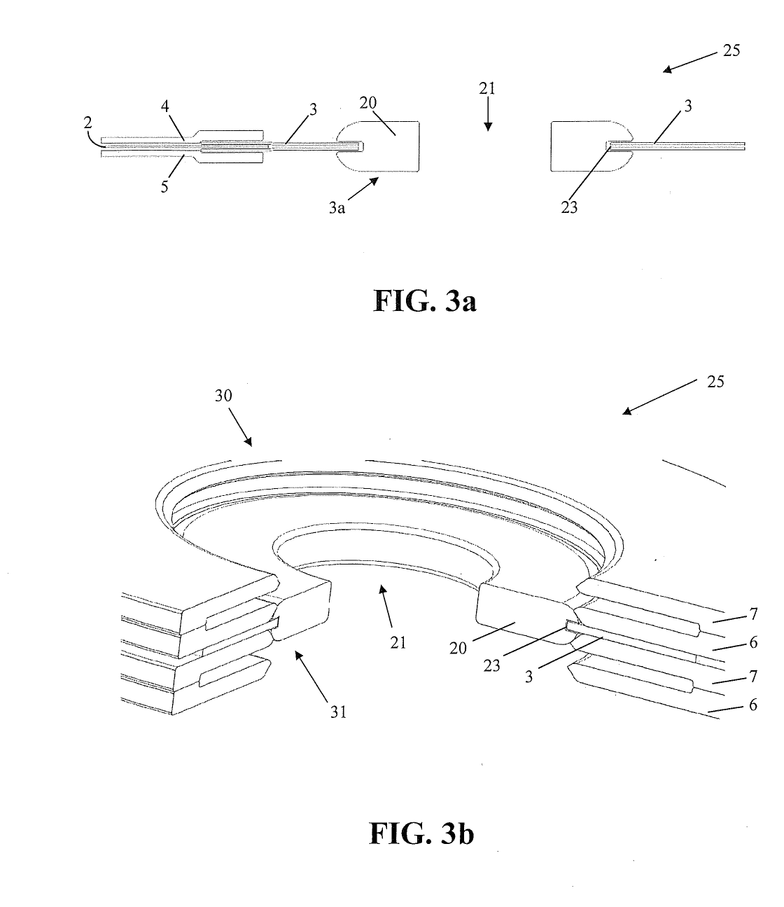

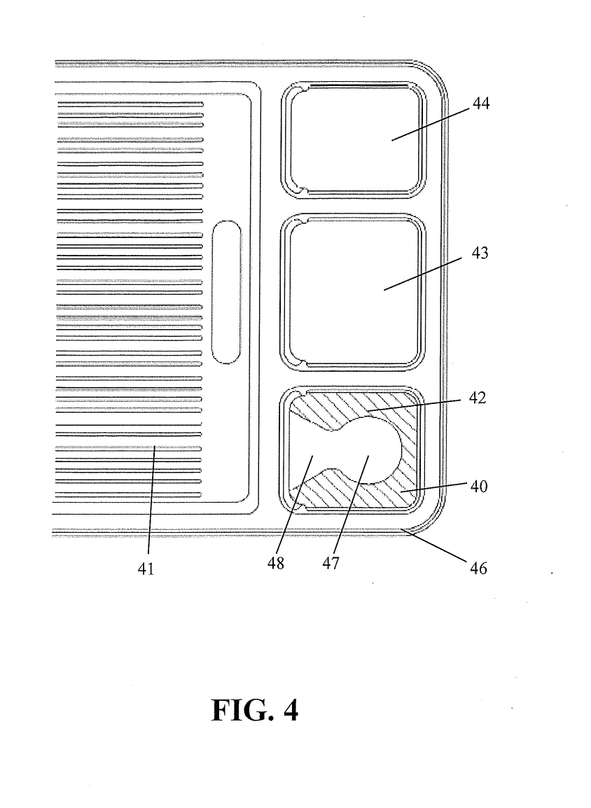

FIG. 2b shows a variant of disc shaped alignment feature 20 which includes radial slot 22. Radial slot 22 may be provided to allow for a desired flow of fluid from the centre of feature 20 to its periphery, for instance in embodiments where the common datums also serve as fluid ports in the fuel cells (e.g. as shown in FIG. 4). FIG. 2c shows another variant of disc shaped alignment feature 20 which includes peripheral slot 23. Peripheral slot 23 may be provided to locate and trap the frame of a MEA therein for alignment purposes (e.g. as shown in FIGS. 3a and 3b).

As mentioned above, the alignment features of the invention can optionally be used to align the MEAs in the stack as well as to align the bipolar plates. FIG. 3a shows a side sectional schematic view of how this might be accomplished in embodiments using framed MEAs. In FIG. 3a, frame 3 of framed membrane electrode assembly 2 comprises a hole (common datum) 3a. And frame 3 is trapped (via snap fit preferably) in peripheral slot 23 of tapered alignment feature 20. With anode GDL 4 and cathode GDL 5 appropriately bonded to CCM 2, this results in a convenient framed cell assembly 25 which can be easily handled and aligned in subsequent stack assembly operations.

FIG. 3b illustrates how framed cell assemblies 25 might then be readily aligned and stacked together with the other stack components. FIG. 3b shows an isometric sectional schematic view of a fuel cell stack in the vicinity of tapered common datums (circular openings) 30, 31 of two adjacent bipolar plate assemblies (comprising anode plates 6 and cathode plates 7). For example on assembly, framed cell assembly 25 can first be roughly aligned into place with respect to common datum 31 of the lower bipolar plate assembly 6, 7 but thereafter is accurately guided into final alignment via use of the tapers on common datum 31 and alignment feature 20. The upper bipolar plate assembly 6, 7 shown in FIG. 3b can then be accurately aligned and stacked in a like manner by aligning common datum 30 to feature 20.

FIG. 4 illustrates a different embodiment of the invention. Shown here is a top view in the vicinity of the fluid ports at an end of a bipolar plate assembly. Visible in FIG. 4 is the fuel flow surface of anode plate 46, which comprises fuel flow field 41 and several major fluid ports, including fuel inlet port 42, coolant inlet port 43, and oxidant inlet port 44. Here, fuel inlet port 42 is used to serve as the common datum opening for alignment purposes on assembly. Also visible in FIG. 4 is alignment feature 40 which engages with a cathode plate below anode plate 46 and bonded thereto (this cathode plate is not visible in FIG. 4) and also engages with the anode side of an adjacent bipolar plate further below anode plate 46 (this adjacent bipolar plate assembly is also not visible in FIG. 4). Alignment feature 40 is shaped appropriately to fit into, and align with, fuel inlet port 42. Alignment feature 40 also comprises a substantial centre hole 47 and radial slot 48 in order to allow for an acceptable flow of fuel through port 42 and also into flow field 41 via an internal backfeed port formed in plate 46 on the left side of port 42 (not visible however in FIG. 4).

Further, the alignment features of the invention can optionally be used to align anode plate 6 and cathode plate 7 in preparing bipolar plate assemblies prior to assembling the rest of the stack. In such a case, typically feature 20 would be appropriately shaped to engage common datum openings of the coolant sides of anode plate 6 and cathode plate 7 while still serving to engage an adjacent bipolar plate during later assembly of the stack.

Alternatively however, other alignment features and/or other methods (not shown), that are independent of alignment features 20, may be used specifically to align anode plate 6 and cathode plate 7 for preparing bipolar plate assemblies. For instance, the plates making up the bipolar plate assemblies might be aligned in a like manner as the bipolar plate assemblies are aligned in the present invention. That is, the plates may have additional common datum openings in which separate discrete alignment features similar to alignment feature 20 may be used in a like manner to align and engage the plates making up the individual bipolar plate assemblies. Alternatively, various other configurations of alignment features may be employed comprising in-plane and/or out-of-plane features formed on the coolant sides of the anode and cathode plates. For instance, a first set of in-plane alignment features may be formed on the coolant side of one plate and a mating second set of out-of-plane alignment features may be formed on the coolant side of the other plate. Depending on the configurations employed, with proper design, the additional features may even be removable after assembly if desired.

The preceding figures show several advantageous embodiments of the invention. As will be apparent to those in the art, other datums and datum openings may be employed in the plates or frames for other alignment purposes in addition to those disclosed here. And of course, numerous shapes and configurations may be considered for the alignment features depending on the specific fuel cell stack designs involved.

Using alignment features as proposed above reduces the alignment tolerance stack up by replacing the misalignment items relating to use of external fixtures. In one practical embodiment, the flowfield alignment variance can be reduced by over 40%, which in turn results in a significant performance gain. Further, use of such alignment features improves the structural stability of the assembled fuel cell stack. In particular, reduced latitudinal loading is generated between cell components, and so the stack is less prone to buckling. Further still, the various risks (as discussed above) that are faced during manufacture are reduced. The cell components can partially self-assemble with faster, less accurate placement. And manufacturing cycle time and capital equipment cost can also be reduced.

All of the above U.S. patents, U.S. patent application publications, U.S. patent applications, foreign patents, foreign patent applications and non-patent publications referred to in this specification, are incorporated herein by reference in their entirety.

While particular elements, embodiments and applications of the present invention have been shown and described, it will be understood, of course, that the invention is not limited thereto since modifications may be made by those skilled in the art without departing from the spirit and scope of the present disclosure, particularly in light of the foregoing teachings. Such modifications are to be considered within the purview and scope of the claims appended hereto.

What is claimed is:

1. A solid polymer electrolyte fuel cell stack comprising:
a plurality of membrane electrode assemblies;
a plurality of bipolar plates separating the membrane electrode assemblies wherein each bipolar plate comprises an anode side, a cathode side, and a common datum opening, and wherein the common datum openings of each bipolar plate are in alignment; and
a plurality of alignment features wherein the stack comprises one alignment feature for each adjacent pair of common datum openings in adjacent bipolar plates and wherein each alignment feature engages the common datum opening of the anode side of one bipolar plate and the common datum opening of the cathode side of an adjacent bipolar plate.

2. The fuel cell stack of claim 1 wherein each alignment feature lies within the planes defined by the external surfaces of the bipolar plates to which it is engaged.

3. The fuel cell stack of claim 1 wherein each alignment feature is non-electrically conductive.

4. The fuel cell stack of claim 1 wherein each alignment feature is molded polymer.

5. The fuel cell stack of claim 1 wherein each alignment feature is disc shaped.

6. The fuel cell stack of claim 1 wherein each alignment feature is ring shaped.

7. The fuel cell stack of claim 1 wherein the common datum opening is a fluid port in the bipolar plate, each alignment feature comprises a radial slot, and each alignment feature is oriented to allow for flow of the fluid.

8. The fuel cell stack of claim 1 wherein both the common datum openings in the bipolar plates and the peripheries of the alignment features are tapered.

9. The fuel cell stack of claim 1 wherein each alignment feature comprises a peripheral slot.

10. The fuel cell stack of claim 9 wherein each membrane electrode assembly comprises a frame, each frame comprises a common datum opening in alignment with the common datum openings in the bipolar plates, and each frame is trapped in the peripheral slot of an alignment feature.

11. The fuel cell stack of claim 1 wherein each bipolar plate is an assembly comprising an anode plate bonded to a cathode plate.

12. The fuel cell stack of claim 11 wherein each alignment feature engages the common datum opening of the anode plate and the common datum opening of the cathode side in one of the bipolar plates.

13. The fuel cell stack of claim 11 wherein the anode plate and cathode plate in each bipolar plate assembly comprise an additional common datum opening and an additional alignment feature wherein each additional alignment feature engages the additional common datum opening of the bonded side of the anode plate and the additional common datum opening of the bonded side of the adjacent cathode plate in each bipolar plate assembly.

14. A unit cell assembly for a solid polymer electrolyte fuel cell stack comprising:
a membrane electrode assembly;
a bipolar plate adjacent the membrane electrode assembly, the bipolar plate comprising an anode side, a cathode side, and a common datum opening; and
an alignment feature in the common datum opening of the bipolar plate.

15. The unit cell assembly of claim 14 wherein the alignment feature comprises a peripheral slot and wherein the membrane electrode assembly comprises a frame, the frame comprises a common datum opening in alignment with the common datum opening in the bipolar plate, and the frame is trapped in the peripheral slot of the alignment feature.

16. A method of aligning a plurality of bipolar plates during assembly of a solid polymer electrolyte fuel cell stack, the fuel cell stack comprising a plurality of membrane electrode assemblies and a plurality of bipolar plates separating the membrane electrode assemblies wherein each bipolar plate comprises an anode side and a cathode side, the method comprising:
incorporating a common datum opening in each bipolar plate such that the common datum openings are all in alignment;
incorporating a plurality of alignment features in the common datum openings; and
stacking the membrane electrode assemblies and the bipolar plates such that each alignment feature engages the common datum opening of the anode side of one bipolar plate and the common datum opening of the cathode side of an adjacent bipolar plate.

17. The method of claim 16 comprising selecting each alignment feature such that it lies within the planes defined by the external surfaces of the bipolar plates to which it is engaged.

18. The method of claim 16 wherein the plurality of incorporated alignment features are non-electrically conductive.

19. The method of claim 16 additionally comprising aligning the plurality of membrane electrode assemblies during assembly of the solid polymer electrolyte fuel cell stack wherein the membrane electrode assembly aligning comprises:
employing membrane electrode assemblies comprising a frame;
incorporating a common datum opening in each frame that is in alignment with the common datum openings in the bipolar plates;
incorporating a peripheral slot in each alignment feature; and
trapping each frame in the peripheral slot of an alignment feature.

20. The method of claim 16 comprising removing the plurality of alignment features in the common datum openings after stacking the membrane electrode assemblies and the bipolar plates.
